(19) United States
(12) Patent Application Publication
(10) Pub. No.: US 2012/0194137 A1
(43) Pub. Date: Aug. 2, 2012

(54) VOLTAGE EQUALIZER FOR BATTERY ASSEMBLY

(75) Inventor: Shih-Yuan Wang, New Taipei (TW)

(73) Assignee: ACBEL POLYTECH INC., New Taipei (TW)

(21) Appl. No.: 13/236,084

(22) Filed: Sep. 19, 2011

(30) Foreign Application Priority Data
Jan. 28, 2011 (TW) 100103228

(51) Int. Cl. H02J 7/00

(52) U.S. Cl. 320/119

(57) ABSTRACT

A voltage equalizer is applied to balance voltages among multiple battery units that are connected in series as a battery assembly. The voltage equalizer has a transformer, a switch and a controller. The transformer has a primary winding connected to the battery assembly and the controller through the switch, and further has multiple secondary windings connected to the battery units respectively. When the switch is alternately turned on and off, the transformer draws energy from the battery units with the higher voltage and couples the energy to the secondary windings to charge the battery unit with the lower voltage for balancing the voltages of the battery units.

### BACKGROUND OF THE INVENTION

1. Field of the Invention

The invention relates to a voltage equalizer for a battery assembly, and more particularly to a voltage equalizer that balances voltages among multiple battery units of the battery assembly by a relatively simple circuit configuration.

2. Description of Related Art

Batteries are often connected in series or parallel to form a battery assembly according to different applications as demanded. When the batteries are connected in series as a battery string, a charging current flowing through each of the batteries of the battery string is identical. Because of manufacturing material, manufacturing processes, operating environment, operating temperature, etc., each battery may differ from others in voltage or power capacity. Therefore, some of the batteries may be over charged while others are insufficiently charged. A battery voltage is usually used as an important factor to determine the charging status of a battery. When a battery has been over charged, the charging power applied to the battery will transform into heat energy to increase temperature of the battery assembly. Thus, life of the battery assembly will be reduced significantly and each battery may be subjected to a permanent damage. Therefore, a voltage equalizer is necessary to protect each battery from being over charged.

The conventional voltage equalizers may comprise different types described hereinafter.

1. Zener diode-based voltage equalizer: With reference to FIG. 4, a Zener diode 41 is connected in parallel to a battery. A maximum voltage across the battery will be limited to a breakdown voltage of the Zener diode 41. However, when the Zener diode 41 fails, it will be equivalent to a short circuit and still consume energy. The energy consumption depends on the size of the Zener diode 41.

2. Resistor-based voltage equalizer: With reference to FIG. 5, the voltage equalizer comprises multiple resistors 51-54, multiple switches 55-57 and a controller 58. The resistors 51-54 are connected to the batteries. Each of the switches 55-57 is connected between two adjacent resistors 51-54 and is turned on or off by the controller 58. Although the voltages of the batteries can be adjusted to be equivalent, the extra energy of the batteries is consumed by the resistors 51-54 and will not be efficiently used.

3. Inductor-based voltage equalizer: With reference to FIG. 6, taking two batteries in series as an example, one end of an inductor 61 is connected to a node where the two batteries are connected together, and the other end of the inductor 61 is connected to two switches 62, 63. In order to control the switches 62, 63, the voltage equalizer needs to precisely detect voltage status of each battery. Therefore, a control circuit for the inductor-based voltage equalizer is complicated and the cost of such voltage equalizer is relatively high.

4. Capacitor-based voltage equalizer: With reference to FIG. 7, the voltage equalizer comprises a capacitor and switches and achieves voltage balancing by alternately switching the switches. Similar to the foregoing inductor-based voltage equalizer, a control circuit for the capacitor-based voltage equalizer is also complicated.

For most of the above-mentioned voltage equalizers, each battery has to cooperate with a switch. Because the voltage equalizer is comprised of a large number of electronic components, the reliability of the voltage equalizer will be decreased. For example, if a battery string is composed of N batteries connected in series, N switches or N−1 inductors are required. Furthermore, N pulse-width-modulation (PWM) signals are applied to respectively control the N switches.

### SUMMARY OF THE INVENTION

The main objective of the present invention is to provide a voltage equalizer to balance voltages among multiple battery units by a relatively simple circuit configuration. Further, the cost and complexity of the voltage equalizer can be reasonably reduced. In another aspect, the voltage equalizer will provide superior reliability.

The voltage equalizer in accordance with the present invention has a transformer, a switch and a controller. The transformer has a primary winding connected to the battery assembly and the controller through the switch, and further has multiple secondary windings connected to the battery units respectively. When the switch is alternately turned on and off, the transformer draws energy from the battery units with the higher voltage and couples the energy to the secondary windings to charge the battery unit with the lower voltage for balancing the voltages of the battery units.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first embodiment of a voltage equalizer in accordance with the present invention;

FIG. 2 illustrates different waveforms of the voltage equalizer in accordance with the present invention;

FIG. 3 is a circuit diagram of a second embodiment of a voltage equalizer in accordance with the present invention;

FIG. 4 is a circuit diagram of a conventional Zener diode-based voltage equalizer;

FIG. 5 is a circuit diagram of a conventional resistor-based voltage equalizer;

FIG. 6 is a circuit diagram of a conventional inductor-based voltage equalizer; and

FIG. 7 is a circuit diagram of a conventional capacitor-based voltage equalizer.

### DETAILED DESCRIPTION OF THE PREFERRED EMBODIMENT

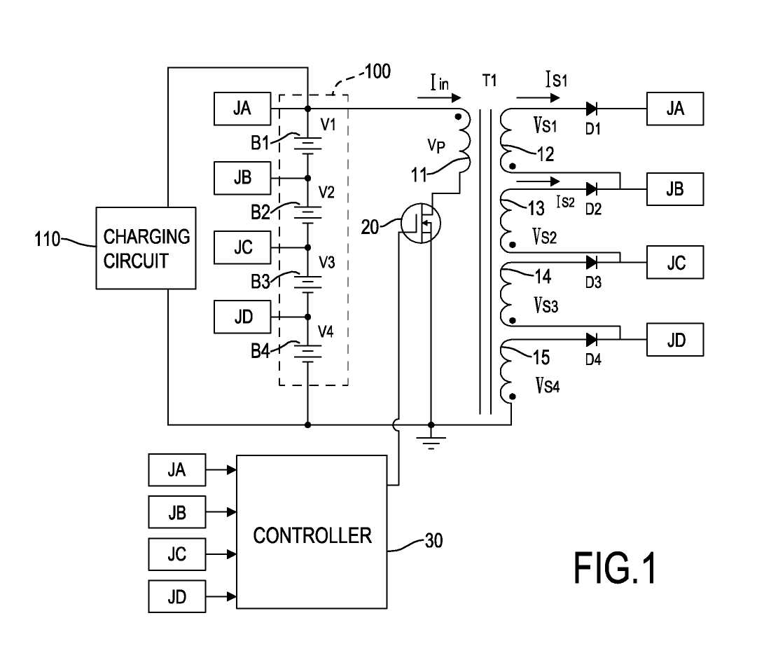

With reference to FIG. 1, a first embodiment of a voltage equalizer is applied to balance voltages among multiple battery units B1-B4 connected in series. The battery units B1-B4 form a battery assembly 100 and are charged by a charging circuit 100. Each of the battery units B1-B4 may be a single battery or multiple batteries connected in series. The voltage equalizer comprises a fly-back transformer T1, a switch 20 and a controller 30.

The fly-back transformer T1 comprises a primary winding 11 and multiple secondary windings 12-15. The number of the secondary windings 12-15 is the same as the number of the battery units B1-B4. The primary winding 11 has a first end and a second end, wherein the first end is connected to one end of the battery assembly 100, and the second end is connected to the switch 20. Each of the secondary windings 12-15 is connected across a respective battery unit B1-B4 through a forward-direction diode D1-D4.

In more detail, each of the secondary windings 12-15 has a first end and a second end. The first ends of the secondary windings 12-15 are connected to anodes of the multiple diodes D1-D4 respectively. The second end of the last secondary winding 15 is connected to ground while the second ends of other secondary windings 12-14 are connected to cathodes of the subsequent diodes D2-D4 respectively. The cathodes of the forward-direction diodes D1-D4 are further respectively connected to the battery units B1-B4.

The switch 20 is connected between the second end of the primary winding 11 and the ground and has a control terminal. The switch 20 may be a MOS transistor having a gate as the control terminal.

The controller 30 detects a voltage V1-V4 across each battery unit B1-B4 and is connected to the control terminal of the switch 20. The controller 30 outputs a switching signal V_{G} to turn on or off the switch 20.

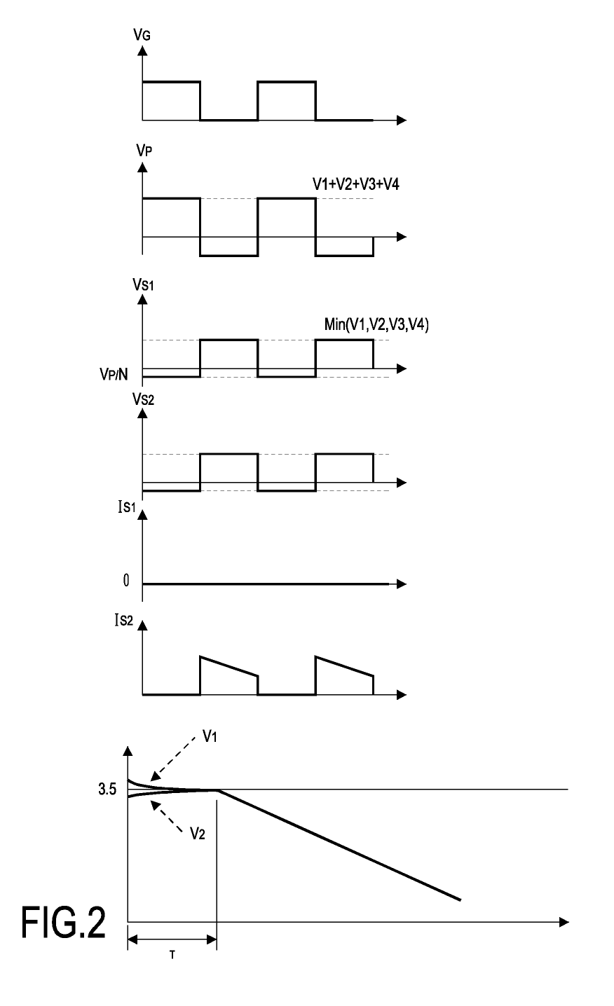

With reference to FIG. 2, the circuit operation of the voltage equalizer is explained by different stages as follows.

1. When the battery units B1-B4 are charged and the controller 30 is activated and detects the occurrence of inconsistent voltages V1-V4 among the battery units B1-B4, i.e. the voltage V1-V4 of any battery unit B1-B4 is different from others, the controller 30 outputs the switching signal V_{G} to the switch 20. When the switch 20 is turned on during the high level periods of the switching signal V_{G}, the fly-back transformer T1 draws energy from the battery assembly 100. Therefore, a current flows through the primary winding 11. Because the battery units B1-B4 are connected in series and a current flowing through the battery units B1-B4 is the same, the fly-back transformer T1 draws more energy from the battery unit B1-B4 having a higher voltage V1-V4 and draws less energy from the battery unit B1-B4 having a lower voltage V1-V4. A maximum voltage (V_{P}) detectable from the primary winding 11 will be the sum total of the voltages V1-V4 of all battery units B1-B4.

2. When the switch 20 is turned off during the low level periods of the switching signal V_{G}, polarities on the primary winding 11 and on the secondary windings 12 will be reversed, and the energy stored in the primary winding 11 will be coupled to the secondary windings 12-15 to induce a charging current. As an example, if the second battery unit B2 has the lowest voltage V2, the second diode D2 connected to the second secondary winding 13 will be conducted firstly prior to other diodes. Because all the secondary windings 12-15 have the same number of coil turns, voltages of each secondary winding 12-15 is limited to V2 (ignoring a forward conduction voltage of the diode D2). Only the second secondary winding 13 has a charging current I_{S2} for charging the second battery unit B2. The second diode D2 ensures the flowing direction of the charging current I_{S2} from the secondary winding 13 to the second battery unit B2. Since other secondary windings 12, 14 and 15 have no charging current, the voltage V2 of the second battery unit B2 will rise gradually.

3. After a period T of operation time, the voltages V1-V4 of all battery units B1-B4 will be substantially equivalent. The controller 30 stops its operation to reduce power consumption of the battery units B1-B4.

4. The period T of operation time may be a default constant period or determined by the controller 30 according to the voltages V1-V4 of the battery units B1-B4.

The voltage equalizer of the present invention uses fewer electronic components to achieve the objective of voltage balancing, particularly only using one single switch 20. The number of the secondary windings 12-15 is the same as that of the battery units B1-B4. Therefore, the cost and complexity of the voltage equalizer can be reasonably reduced. In another aspect, the voltage equalizer will provide superior reliability.

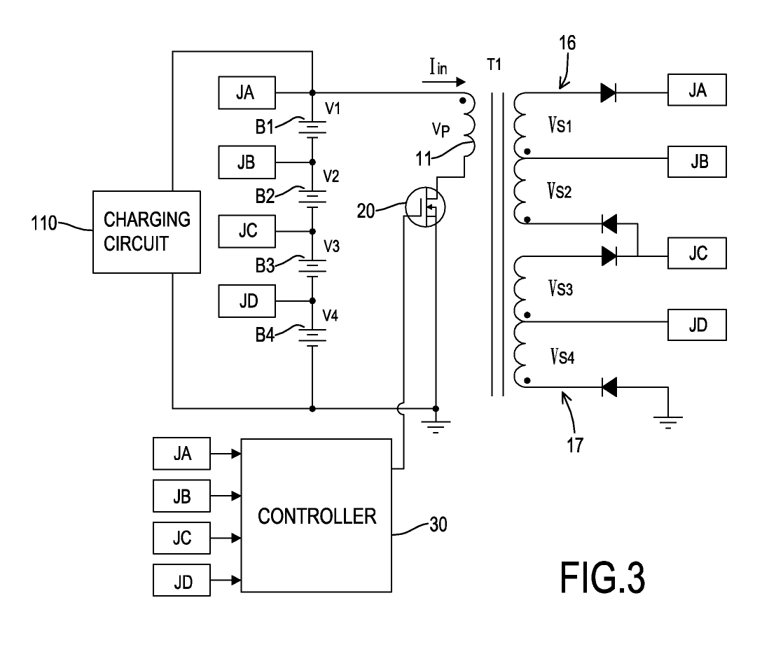

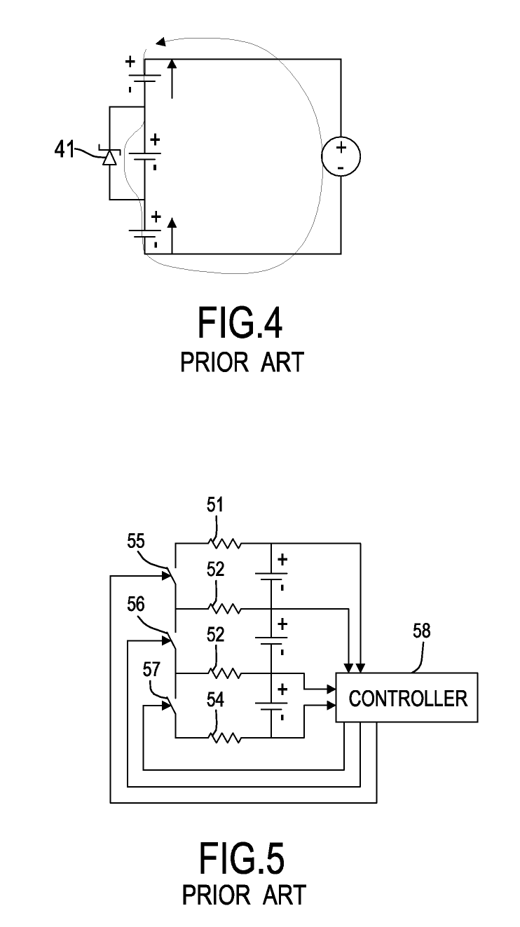

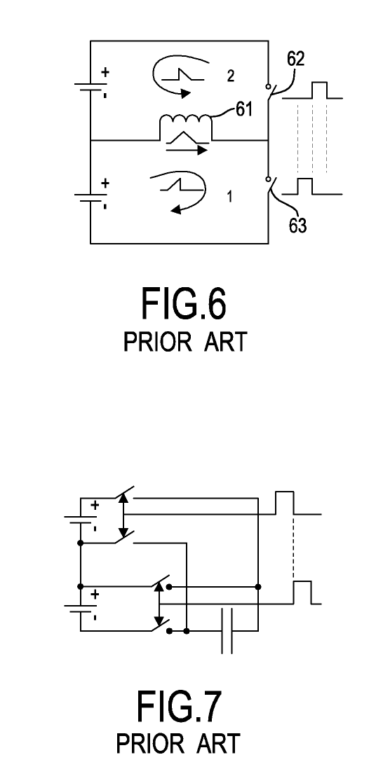

With reference to FIG. 3, a second embodiment of the voltage equalizer is similar to the previous first embodiment, and only the secondary windings of the fly-back transformer T1 have been modified. The secondary windings 16, 17 are reduced in number to a half of the battery units B1-B4. Each of the secondary windings 16, 17 has a central tap so as to provide three output terminals. The first output terminal of each secondary winding 16, 17 is connected to a respective battery unit B1, B3 through a forward-direction diode. The central tap as the second output terminal is connected to another respective battery unit B2, B4. The third output terminal is connected to either the first output terminal of a subsequent secondary winding 17 or the ground through a reverse-direction diode.

With the central tap configuration, the second embodiment has the advantage of the reduced secondary windings 16, 17. In comparison to the first embodiment, the number of the secondary windings is reduced from 8 to 6.

In conclusion, the voltage equalizer in accordance with the present invention uses a single switch and a transformer to balance voltages among the series-connected battery units. The total number of electronic components is much fewer than that of inductor-based or capacitor-based voltage equalizers.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A voltage equalizer for a battery assembly having multiple battery units connected in series, the voltage equalizer comprising:
a transformer comprising
a primary winding having a first end and a second end, wherein the first end is connected to the battery assembly; and
multiple secondary windings, each of the secondary windings connected across a respective battery unit through a respective forward-direction diode;
a switch connected between the second end of the primary winding and ground; and
a controller connected to each of the battery units and the switch, outputting a switching signal to turn on or off the switch; the transformer drawing energy from the battery assembly when the switch is turned on, and coupling the energy to the secondary windings to charge the battery unit having the lowest voltage among all battery units when the switch is turned off.

2. The voltage equalizer as claimed in claim 1, wherein the switch is a MOS transistor having a gate as a control terminal receiving the switching signal output from the controller.

3. The voltage equalizer as claimed in claim 1, wherein the transformer is a fly-back transformer.

4. The voltage equalizer as claimed in claim 2, wherein the transformer is a fly-back transformer.

5. The voltage equalizer as claimed in claim 3, wherein a number of the secondary windings of the transformer is the same as that of the battery units.

6. The voltage equalizer as claimed in claim 4, wherein a number of the secondary windings of the transformer is the same as that of the battery units.

7. The voltage equalizer as claimed in claim 3, wherein the secondary windings have the same number of coil turns.

8. The voltage equalizer as claimed in claim 4, wherein the secondary windings have the same number of coil turns.

9. The voltage equalizer as claimed in claim 1, wherein each of the secondary windings has a first end and a second end;
the first end of each secondary winding is connected to an anode of the respective forward direction diode;
the second end of the last secondary winding is connected to ground while the second ends of other secondary windings are connected to cathodes of subsequent diodes respectively; and
the cathodes of the forward-direction diodes are respectively connected to the battery units.

10. A voltage equalizer for a battery assembly having multiple battery units connected in series, the voltage equalizer comprising:
a transformer comprising
a primary winding having a first end and a second end, wherein the first end is connected to the battery assembly; and
multiple secondary windings, each of the secondary windings having a central tap and connected to two respective battery units;
a switch connected between the second end of the primary winding and ground; and
a controller connected to each of the battery units and the switch, outputting a switching signal to turn on or off the switch; the transformer drawing energy from the battery assembly when the switch is turned on, and coupling the energy to the secondary windings to charge the battery unit having the lowest voltage among all battery units when the switch is turned off.

11. The voltage equalizer as claimed in claim 10, wherein the switch is a MOS transistor having a gate as a control terminal receiving the switching signal output from the controller.

12. The voltage equalizer as claimed in claim 10, wherein the transformer is a fly-back transformer.

13. The voltage equalizer as claimed in claim 11, wherein the transformer is a fly-back transformer.

14. The voltage equalizer as claimed in claim 12, wherein a number of the secondary windings of the transformer is half that of the battery units.

15. The voltage equalizer as claimed in claim 13, wherein a number of the secondary windings of the transformer is half that of the battery units.

16. The voltage equalizer as claimed in claim 12, wherein the secondary windings have the same number of coil turns.

17. The voltage equalizer as claimed in claim 13, wherein the secondary windings have the same number of coil turns.

18. The voltage equalizer as claimed in claim 10, wherein each of the secondary windings of the transformer comprises
a first terminal connected to a respective battery unit through a diode; and
a second terminal formed by the central tap connected to another respective battery unit.
